(19) United States
(12) Patent Application Publication
(10) Pub. No.: US 2014/0136962 A1
(43) Pub. Date: May 15, 2014

(54) Method and System for Detecting and Removing Printer Control Marks from Rasterized Image for Placement in Image Container of Document Template

(71) Applicant: VISTAPRINT TECHNOLOGIES LIMITED, Hamilton (BM)

(72) Inventor: Cameron Fischer, Cambridge, MA (US)

(73) Assignee: VISTAPRINT TECHNOLOGIES LIMITED, Hamilton (BM)

(21) Appl. No.: 13/674,271

(22) Filed: Nov. 12, 2012

(51) Int. Cl. G06F 17/00

(52) U.S. Cl. CPC G06F 17/00
USPC 715/250

(57) ABSTRACT

Methods and systems for processing images for insertion into a selected image container of a document template include processing the received image to determine whether the received image contains any printer control marks and providing an indication if the received image contains one or more printer control marks.

The present invention relates to computer-implemented automated electronic product design.

### BACKGROUND OF THE INVENTION

Many individuals, businesses, and organizations occasionally have a need for custom printed materials, such as business cards, product or service brochures, promotional postcards, personalized holiday cards, or any number of other items. Some of these individuals and businesses turn to sources such as a local print shop for assistance in preparing the materials. These same individuals, businesses and organizations also often have a need for custom electronic products such as websites, mobile-ready websites, social media pages, and other documents that are viewable on an electronic medium. Those having access to a suitable computer may perform the product design process themselves using any of the various specialized software products available for purchase and installation on an appropriate computer system or by using a Web-based service provider that takes advantage of the capabilities of the Web and modern Web browsers to provide printed and/or electronic document design services from any computer with Web access at whatever time and place is convenient to the user.

Computerized design products and Web-based service providers often provide their customers with the ability to access and view pre-designed product templates and enter text and images, and change color schemes and text font, to create a customized product design. Generally, the template provider has individually designed each template by defining various details of the template, such as the size and position of all image and text areas in the template, selecting images, cropping (if necessary) and positioning the selected images, defining colors to be used for template elements having a color attribute, and so forth. The template designer adjusts the various design elements until the designer is satisfied with the overall appearance of the template. User editing is usually limited to allowing the user to add, modify and position text, change the color scheme and font scheme, and in some cases, to select different images. Some template providers also often allow the user of the template to upload images to be inserted into a placeholder image container in the template design.

Generally speaking, a computerized design product and/or Web-based service provider typically provides a library of images which may be used in the design of a customized printed and/or electronic product. The images provided by the design product or service have typically been prepared to fit properly within the dimensions of one or more image containers, and the image content has been approved by a designer as containing only image content (i.e., artwork) and no extraneous content such as printer control marks. However, when an image is uploaded or otherwise provided by a user of the design product or service for insertion into an image container of a selected template, the image may not always contain only the desired image artwork. This may occur for several reasons. First, some computerized photo-finishing, graphic design, or image processing products, for example Adobe InDesign, Adobe Illustrator, Quark, and others, allow a user to save the file in a print-ready format, such as a .pdf format. Often, such products have features that allow the print-ready file to include printer control marks such as crop marks, registration marks, color calibration marks, and also additional bleed area. Often, image processing service providers such as photo and document print shops require the print-ready files to include a specified bleed area and crop marks. A user who prepares a print-ready file containing the image may thus knowingly instruct the computer program (e.g., Adobe InDesign, Adobe Illustrator, Quark, etc.) to include such printer control marks. In other instances, the user may be unaware that the computer program configuration is set to add printer control marks, which are thus added to the print-ready file and are thus included in the image. If the user does not preview the image, such user may not even realize that such printer control marks are included in the print-ready file. Finally, a user may scan a hard-copy of a printed photograph. Often, printed photographs contain printer control marks such as crop marks.

When a user provides, for example by selecting from a local library of user images, or uploads a print-ready file containing printer control marks to a Web-based print or electronic product design service for insertion into an image container of a selected template, the user is therefore often (1) unaware that the image file print-ready file or scanned image file) contains printer control marks, or (2) aware that the image contains printer control marks but believes the printer control marks will be not appear in the final product. Unfortunately, in both cases, the printer control marks will indeed appear when the uploaded image file is inserted into an image container of the selected template. The end result is a final product design that does not appear as the user assumed it would, leading to end-user disappointment and/or frustration.

It would therefore be desirable to provide a mechanism for alerting customers to potential issues related to the existence of printer control marks in images intended to be inserted into image containers of a user-customized template so that such problems, if undesired, can be addressed prior to ordering of a finished product. It would also be desirable to provide a mechanism for detecting and automatically removing such detected printer control marks, especially at the customer's discretion, from images inserted into a template for an electronic document.

### SUMMARY

The present invention is directed to satisfying the need for computer implemented systems and methods that detect and provide options for removing printer control marks in images that are to be inserted into design templates.

In accordance with one embodiment of the invention, a method is provided for processing images for insertion into a selected image container of a document template. The method includes receiving a rasterized image, processing the received image to determine whether the received image contains any printer control marks, and providing an indication if the received image contains one or more printer control marks.

In accordance with another embodiment of the invention, a system for detecting and indicating that an image to be inserted into an image container of a product design template contains printer control marks includes one or more processors configured to receive an image, process the image to determine whether the image contains printer control marks, and providing a visual indicator to the user that the image contains printer control marks.

In one or more embodiments, the system and method may perform automatic cropping of the image to produce a cropped version of the image which may be inserted into the image container in place of the original image.

### BRIEF DESCRIPTION OF THE DRAWINGS

FIG. 1A is a representation of various printed products which can be generate using templates;

FIG. 1B is a representation of an example of an electronic product which can be generate using templates, namely a web page displayed on a computer monitor;

FIG. 2 is a schematic diagram of a template design;

FIG. 3A is an example of an image which does not contain printer control marks;

FIG. 3B is an example of an image which does contain printer control marks;

FIG. 4A illustrates an example graphical user interface of a product design tool which displays a product design image of a selected product template while being customized by a user;

FIG. 4B illustrates an example graphical user interface of a product design tool which displays a product design image of a selected product template during a later stage of being customized by a user;

FIG. 4C illustrates an example graphical user interface of a product design tool which displays a product design image of a selected product template after a user has selected an image container to select an image to insert therein, including a control to browse for and select an image;

FIG. 4D illustrates an example graphical user interface of a product design tool which displays a product design image of a selected product template which includes an image with printer control marks inserted in an image container;

FIG. 5 is a schematic block diagram in which an embodiment of the invention may operate;

FIG. 6 is a flowchart of an exemplary method for determining whether an image has printer control marks and options for insertion into an image container;

FIG. 7 is a flowchart of an exemplary method for detecting whether the image contains printer control marks and automatically cropping the image

FIG. 8A illustrates the graphical user interface of FIGS. 4A-4C and includes an indicator displayed to the user when a selected image for insertion into a template image container contains printer control marks; and

FIG. 8B illustrates the graphical user interface of FIG. 8A after a user selects the system adjusted image for insertion into the template.

### DETAILED DESCRIPTION

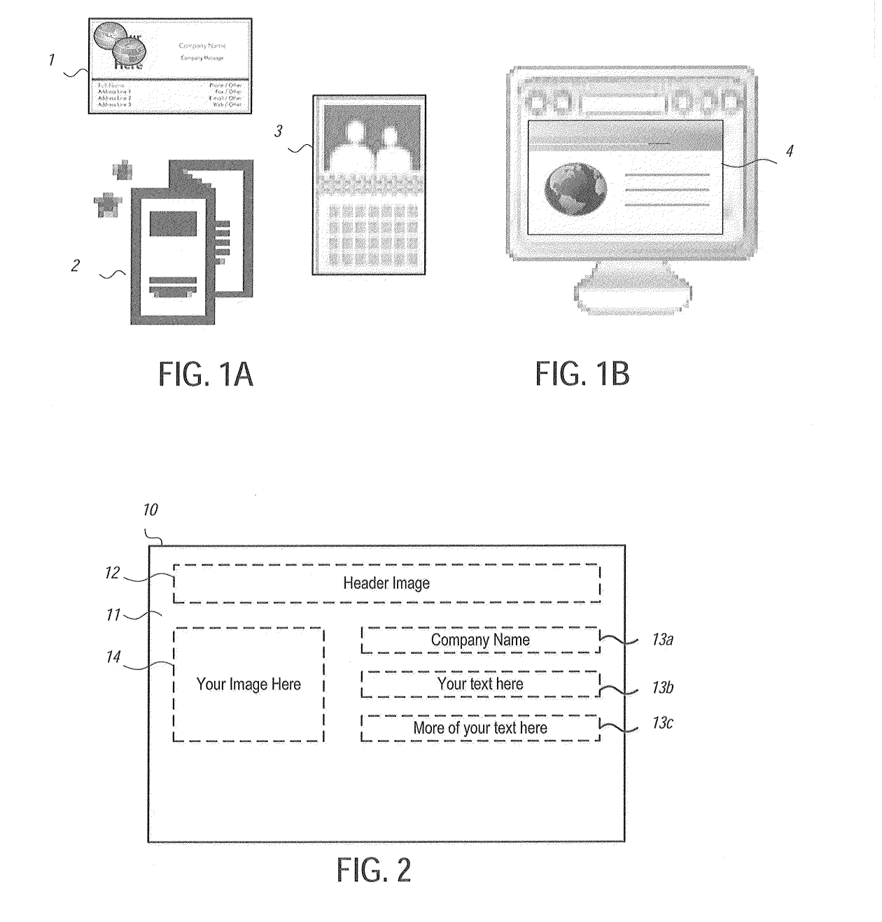

FIG. 1A depicts a number of different examples of printed documents, including a business card 1, a brochure 2, and a wall calendar 3. FIG. 1B depicts an example electronic document, which in the depicted embodiment is an example web page rendered on a display screen of an electronic display, for example on a computer monitor, a laptop or tablet display, a smartphone screen, etc. Each printed and electronic document is a composite of different text and images.

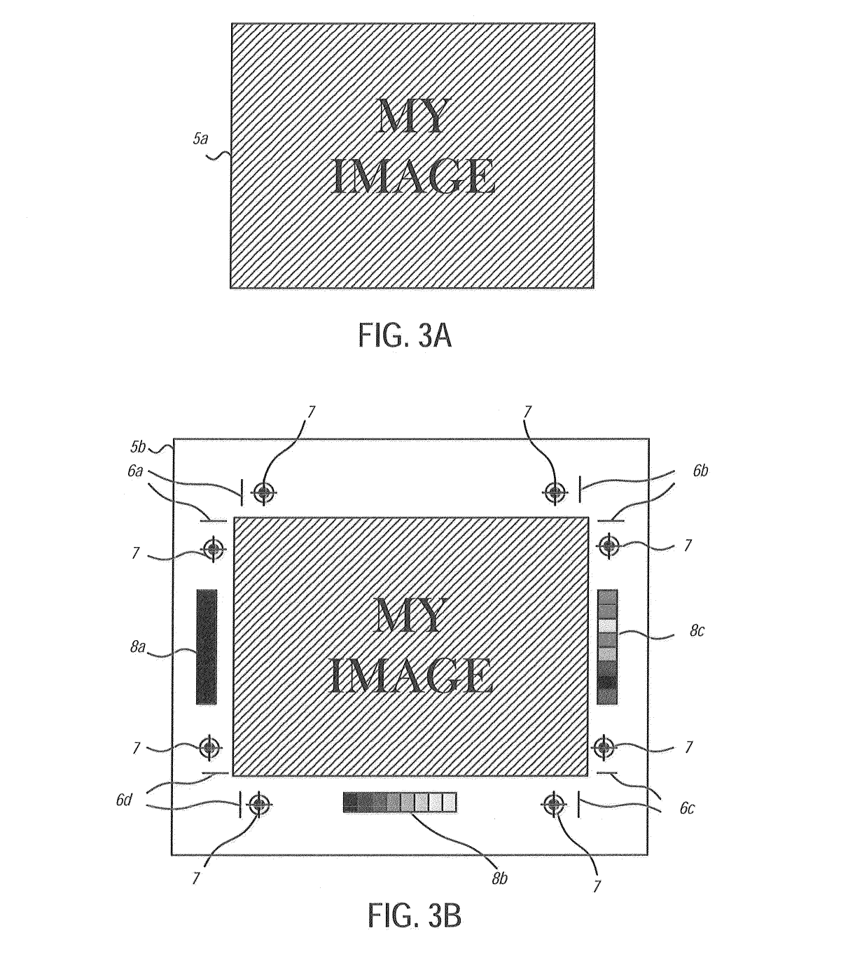

FIG. 2 illustrates an exemplary template design document 10. As illustrated, the template design document includes a number of different components, including a background 11, a header image 12, text boxes 13a, 13b, 13c, and image container 14, each of which includes attributes such as container dimensions, container position, container content, font schemes, color schemes, and whether the particular component is editable or is locked for editing by an end-user, etc. To allow a user to customize the template, the designer of the template configures at least one of the template components as end-user editable. For example, the content of the text boxes 13a, 13b, 13c and the content of the image container 14 may be set as user-editable, whereas the background 11, header image 12, dimensions and position of the image container 14, positions of the text containers 13a, 13b, 13c may be configured as locked (not editable by the user).

In general, the template is stored as an electronic file or description that contains a markup language description of each of the template components (e.g., background, text container, image container, color scheme, font, layout, etc., along with any predefined values for associated component attributes. In order to allow a template to be displayed on an electronic display and used by an end-user of the template to create a customized product, a computer program such as a browser or a product design program accesses the selected template description and renders the described components on the computer display according to the markup language description of each component. Typical markup languages include HyperText Markup Language (HTML), Dynamic HTML (DHTML), Extended HTML (XHTML), etc., each of which is interpreted by a modern browser such as Microsoft's Internet Explorer, Google's Chrome, Mozzilla's Firefox, etc. An example of an exemplary product design tool which is suitable for creating customized products based on predefined templates is described in detail in U.S. application Ser. No. 10/449,836 entitled “Electronic Document Modification”, filed May 20, 2003, the complete contents of which are hereby incorporated by reference into this application, which is hereby incorporated by reference for all that it teaches.

As described above, individual templates may contain one or more of an image container into which an image may be inserted. As further described above, in a typical markup language document, the particular image to be inserted into the image container is specified by image file name as the image source attribute in the image element tag (e.g., in HTML, an image container may be specified as: <IMG ALT=“Your Image Here” SRC=“myURL/myimage.jpg”>). When a customer uploads or otherwise provides an image, the image often contains crop, registration, and/or printer calibration or other control marks used by a printing system for printer process calibration and/or post processing of the image.

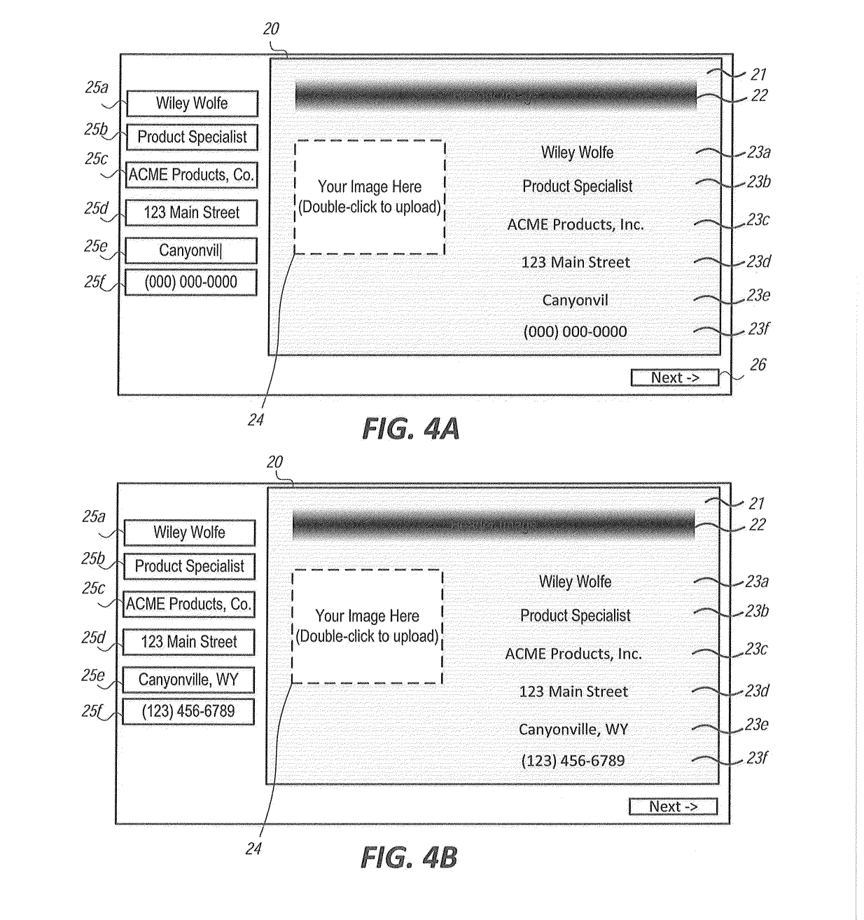

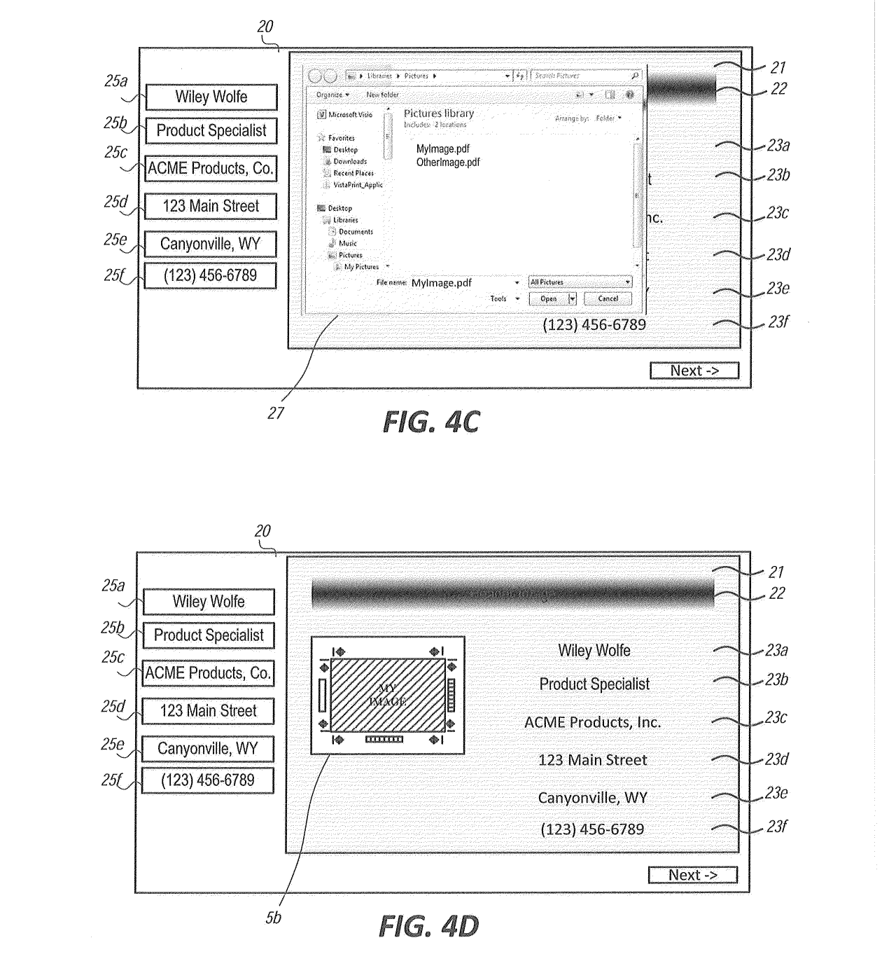

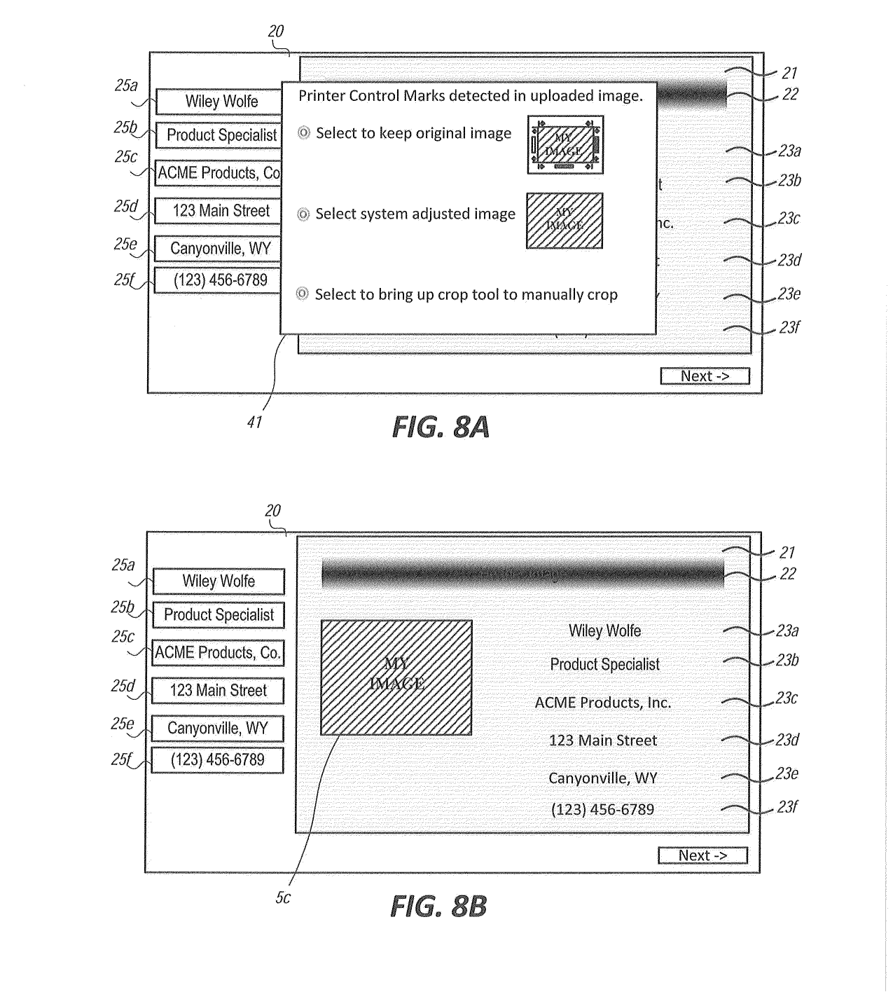

FIG. 3A depicts an example of an image 5a that is rendered from an image file (for example, a raster image file <MyImage.jpg> or a print-ready file (without printer control marks) MyImage.pdf) or other displayable image formats) for display or printing. This image contains no printer control marks and thus when inserted into an image container such as image container 24 in FIGS. 4A-4D and 8A-8B, would appear as expected.

By contrast, FIG. 3B depicts an example of an image 5b that is rendered from an image file (e.g., a print-ready file (.pdf or other print-ready format) or scanned image (.jpg or other raster format)) that does include printer control marks.

Printer control marks are marks along the edges of the image which are used by the printing (and/or cutting) system for use in post-processing or printing system maintenance/analytics. The rendered image 5b in FIG. 3B depicts several common types of printer control marks. One of the most commonly encountered printer control mark is the crop mark, shown at 6a, 6b, 6c, 6d. Crop marks, also called “trim lines”, are used in post-print processing to indicate to the printer or cutter where the printed image is to be cut. Crop marks are generally horizontal and vertical black lines located at or near the corners of a print-ready image which are used by the printing/cutting system to determine where to cut the printed image. Crop marks typically include a horizontal line and a vertical line which may or may not visually intersect at a corner point. The horizontal and vertical lines correspond to the trim lines that a cutter will follow when removing the edges around the artwork portion of the image.

Another common printer control mark is known as a “registration mark”. Registration marks are utilized by a printing and/or cutting systems to align the print substrate (or itself relative to the print substrate) for accurate print and/or cut operations. FIG. 3B illustrates several registration marks at 7.

Still another common printer control mark is known as a “calibration mark”, which is typically a printed pattern designed to fully test the color and/or density of the ink output by the printer. A printed calibration mark may be analyzed by technicians to determine the quality of the print and operates as feedback to the technicians to assist them in making adjustments to the printer to maintain the print quality within a desired specification. Calibrations marks are shown at 8a, 8b, 8c in FIG. 3B.

As described in the background section, printer control marks may be inserted automatically by the design-, photo- or image-processing software that creates the particular image, or they may have been present in an original image that was scanned to create the particular image. When inserting an image into an image container of a selected document template, sometimes the customer uploads the image in a print-ready format, such as a .pdf format. Other times, the customer converts a .pdf or other print-ready format image to a raster image and then uploads the raster image. Other times, a customer uploads the image in a rasterized format, sometimes generated as the result of scanning a hard-copy of an image. In any of the above cases, in many instances the converted or uploaded image may include printer control marks 6a, 6b, 6c, 6d, 7, 8a, 8b, 8c that are undesirable for display in the template in which the image is to be inserted. These printer control marks are included as part of the image that is inserted into an image container of a selected template. Generally, this is undesirable, as the customer's intent is to include only the image content (referred to herein as “artwork”) and not the printer control marks. When inserting an image into an image container of a template, it is therefore desirable that the image inserted therein does not include any printer control marks and that the image is sized to fill at least one dimension of the image container.

FIGS. 4A-4D illustrate an example of an electronic product design tool which allows a user to select a template, customize the template by inserting user-personalized information into one or more text containers and/or image containers, change a font and/or color scheme, etc. In an embodiment, the electronic product design tool is a Web-based tool that is accessible over the Internet from any computer. In an alternative embodiment, the design tool is a program that executes on a user's computer or on a local computer accessible in a networked environment.

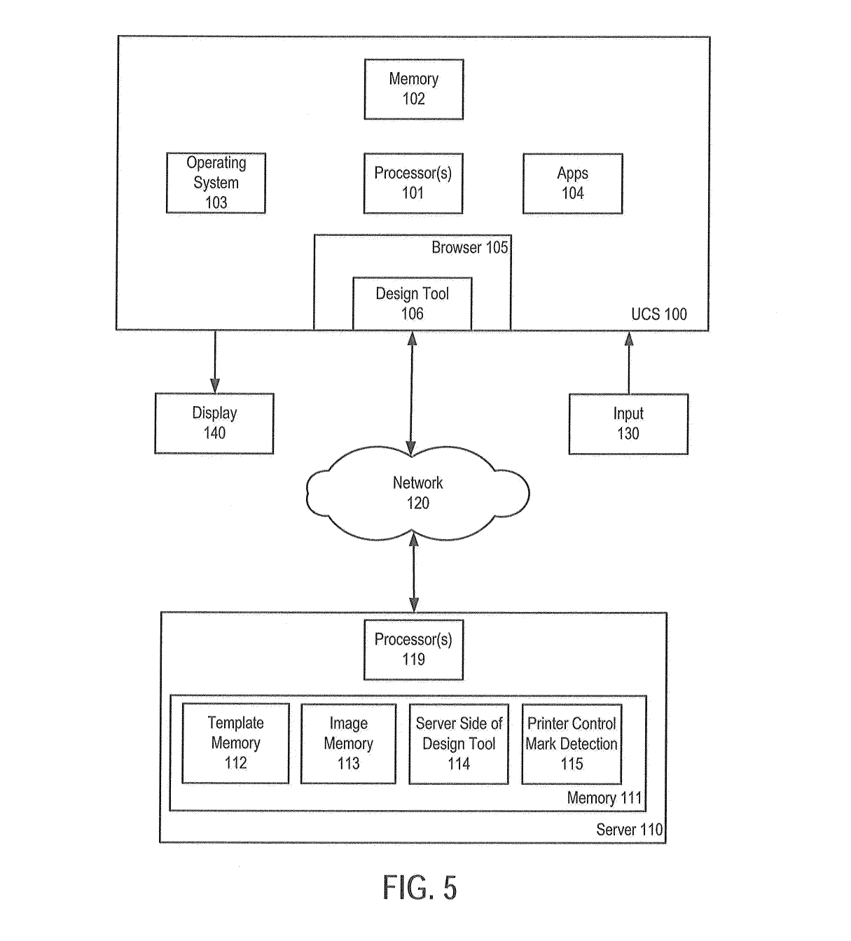

FIG. 5 illustrates an exemplary computerized system in which the invention may operate. Referring to FIG. 5, an exemplary user computer system UCS 100 includes one or more processors 101 and memory 102. Memory 102 represents all UCS 100 components and subsystems that provide data storage, such as RAM, ROM, and hard drives. In addition to providing permanent storage for all programs installed on UCS 100, memory 102 also provides temporary storage required by an operating system 103 and computer applications (i.e., programs) 104 while they are executing as executed by the processor(s) 101. In a preferred embodiment, UCS 100 is a typically equipped personal computer, but UCS 100 could also be portable computer such as a laptop, a pad computer, a smartphone, or other device. The user views images from UCS 100 on display 140, such as a CRT or LCD screen, and provides inputs to UCS 100 via input devices 130, such as (but not limited to) a keyboard and a mouse, or a touchpad.

When UCS 100 is operating, an instance of the USC 100 operating system will be executing, represented in FIG. 5 by operating system 103. In addition, the user may be running one or more application programs 104. In FIG. 5, UCS 100 is running Web browser 105. Other applications that may be running in USC 100, such as spreadsheet, e-mail, and presentation programs, are represented as applications 104. In the depicted embodiment, design tool 106 is a product design program. In the depicted embodiment, the design tool 106 is downloaded to UCS 100 via network 120 from remote server 110, such as downloadable design tools provided by www.vistaprint.com. Design tool 106 runs in browser 105 and allows the user to prepare a customized product design in electronic form. Alternatively, design tool 106 could have been obtained by the user from memory 102 or from another local source. The design tool 106 allows a user to select from a number of available product design templates, customize the template with the user's personal information and/or design choices, to complete a final product design which the user can order for printing (in the case of printed products), publishing (in the case of Web-based products—e.g., websites and Web-accessible pages), or otherwise processing (e.g., convert to an embroidered design for implementation on an embroidered product, an engraving design, etc.). When the customer is satisfied with the design of the product, the design can be uploaded to server 110 for storage and, if desired by the user, subsequent production of the desired quantity of the physical product on appropriate printing and/or post-processing systems. While server 110 is shown in FIG. 1 as a single block, it will be understood that server 110 could be multiple servers configured to communicate and operate cooperatively.

Referring to server 110, in an embodiment the server 110 is a computer system having one or more processors 119 that execute program instructions stored in memory 111 and which communicates with remote computers such as UCS 100 via a network 120. The network connection(s) may include wireless network communication, or wired connections such as a Local or Wide Area Network (LAN, WAN), etc. Memory 111 represents all components and subsystems that provide server data storage, such as RAM, ROM, and disk drives or arrays. Template memory 112 contains the various layout, design, color, font, and other information provided by the service provider to enable the creation and rendering of templates. As used in this embodiment, a layout is a markup language description (such as XML) that specifies the size, position and other attributes of all product elements such as text containers, image containers, graphics, z-index values and so forth.

Image memory 113 represents the portion of memory 111 that contains the images and any related image attributes used b r the service provider to generate the product design, such as the image size, default colors associated with the image, and one or more keywords that have been associated with that image by the printing service provider. Image memory 113 includes a base image and may, but need not, include one or more cropped versions of the base image prepared by the service provider to fit various image container shapes. A wide variety of different templates can be created by combinations of layouts and images. Co-pending and co-owned U.S. application Ser. No. 10/646,554 entitled “Automated Image Resizing and Cropping”, filed Aug. 22, 2003, the complete contents of which are hereby incorporated by reference into this application, discloses document editing systems for combining separately stored images and layouts to create document designs.

Referring now to FIGS. 4A-4D, FIG. 4A is a simplified representation of a product design studio which may be displayed on a display 107 of the UCS 100 when the user navigates to a Web-based customized product vendor, selects a particular product to design, and selects a particular template to use as a starting point in the user's customized design.

As an illustrative example, it will be assumed that the user of UCS 100 desires to create a personalized business card and, therefore, selects the business card option, for example by clicking with the user's mouse cursor on a business card selection control on a web page of the product vendor's website (not shown). The user will then be presented with one or more additional selection screens, not shown, from which the user can review the various business card categories by general theme or subject matter and then, when the desired category is selected, review one or more pages of thumbnail images of business card templates prepared by the service provider. When a desired template thumbnail is located, the user can click on the image to cause server 110 to download the selected template information and initiate a custom product design session. As an alternative to providing a large gallery of thumbnail template images for the user to scan, the service provider could provide a keyword searching tool to allow the service provider to display only thumbnails of templates with images or other content corresponding to the user's search terms.

Referring to FIG. 4A, when the user selects a specific template that the user desires to customize, the user is presented with a larger customizable template image 20 of the selected product design which may contain a wide variety and number of images, colors, graphics and other design elements. For simplicity of discussion, in the example shown in FIG. 4A, template 20 represents one side of a business card being designed by a user. The design contains three image containers, also referred to herein as image areas: a background image area 21 covering the entire side of the postcard template, a header image 22 that spans the top of the card, and an image placeholder container 24 that appears over the background image 21 and which is selectable by the user (for example by double-clicking on the container 24) to bring up a dialog to select an image to insert into the container 24. The template image 20 also includes six text containers 23a-23f which are displayed over the background image 21. As mentioned above, the template 20 displayed to the user is the result of the combination of various separately stored template components including the three images and a markup language description of a layout describing the size and position of the containers for all of the text and image components 21, 22, 23a-23f, 24.

The initial template 20 is the starting point for the user's customized product design. The user can add the user's personalized text into text containers 23a-23f and insert a personalized image into image container 24. Other components, such as the background image 21 and header image 22 are locked and cannot be edited by the end user.

To allow the user to customize the product design, the user is provided with template editing tools. Text form boxes 25a, 25b, 25c, 25d, 25e, 25f, allow the user to enter text which will be entered into the design 20 in corresponding text containers 23a, 23b, 23c, 23d, 23e, 23f. In an embodiment, the template image 20 is a What-You-See-Is-What-You-Get (WYSIWYG) image in that it shows on the display screen exactly what the finished product will look like when printed, published, or otherwise finished. Initially, each text form field 25a-25f includes sample text, which is displayed in the product design image 20 as it will appear in the final product. The sample text is provided to give the user an idea of how the final product will look, including the placement of any text. The user may remove any sample text by editing it, replacing the sample text in the text form fields 25a-25f with personalized text, or may remove any of the text altogether. Accordingly, when a user enters text into one of the form boxes 25a-25f, the text may be sent back to the server 110 to be rendered into an image of the text, and the rendered image of the text is sent back to the UCS 100 and rendered in the specified position as defined by the position attribute of the corresponding text container in the template design description. Thus, what appears in the product design image 20 is what will appear in the final product. In an embodiment, the product design image 20 is updated in realtime as the user types the personalized text content in the form boxes 25a-25f. In FIG. 4A, the user has typed in personal content for form fields 25a-25d, and is in the middle of typing personalized content into text form field 25e, which shows up in the product design image 20 as partially completed. Form box 25f still includes sample text, which has not yet been edited by the user, and the sample text shows up in the design image 20 as the sample text. FIG. 4B shows the product design image 20 after the user has completed filling out text form fields 25e and 25f.

Additional attributes of the components may optionally be customizable by the user, for example tools to allow the user to change fonts, color schemes, add text and/or image containers, reposition text and/or image containers, and perform other typical editing actions, using various buttons, controls and menus (not shown). The techniques for designing and using edit tool bars are well known in the art. Navigation buttons Back (not shown) and Next 26 allow the user to move back to the previous display screen or ahead to the next. Different or additional navigation means could also be employed.

Depending on the level of customizing capabilities the service provider desires to give to the user, the service provider may also choose to provide the user with one or more additional instructions, tools, or controls (not shown) to facilitate user editing of template 20, such as tools for changing the template layout, the color scheme, the design effects, or the font scheme. Co-pending and co-owned U.S. application Ser. No. 10/449,836 entitled “Electronic Document Modification”, filed May 20, 2003, the complete contents of which are hereby incorporated by reference into this application, describes a document editing system and method using separately selectable layouts, designs, color schemes and font schemes.

Design tool 106 provides one or more methods to allow the user to indicate a desire to insert or replace an image in image container 24, for example by positioning the user's mouse cursor over the desired image area and double clicking. Referring to FIG. 4C, in response to the user's action of double clicking while the cursor is positioned over one of the image areas, window 27 is presented to the user. Window 27 offers the user the choice of selecting an image for insertion into the image container 24. Images may be selected from a library of images located at the server 110, from a local library of images accessible at the UCS 100, or from other sources local or remote to the UCS 100.

In the example shown in FIG. 4C, the user has double clicked on image area 24 and then selected an image named MyImage.pdf, indicating a desire to insert the selected image into image container 24. In one example, the image MyImage.pdf contains crop marks, for example as shown at 5b in FIG. 3B. FIG. 4D shows what would happen in prior art systems when the user selects an image containing printer control marks, such as 5a from FIG. 3B. As illustrated, the entire image, including the image artwork and the printer control marks, is inserted and displayed in image container 24 and will appear as shown in product design image 20 in the finished product. As described previously, the inclusion of the printer control marks in the finished product may be undesirable.

Referring again to FIG. 5, there is provided a printer control mark detection function 115, which may be implemented on a computer system (such as system 110) having one or more processors configured to perform computer-readable program instructions which are configured to process a selected image to determine whether the image contains printer control marks and to, preferably, automatically crop the image and resize it to the original dimensions if printer control marks are detected. The printer control mark detection function 115 may operate in conjunction with the design tool (server side of design tool 114 and/or client side of design tool 106) to present options to the user if printer control marks are detected.

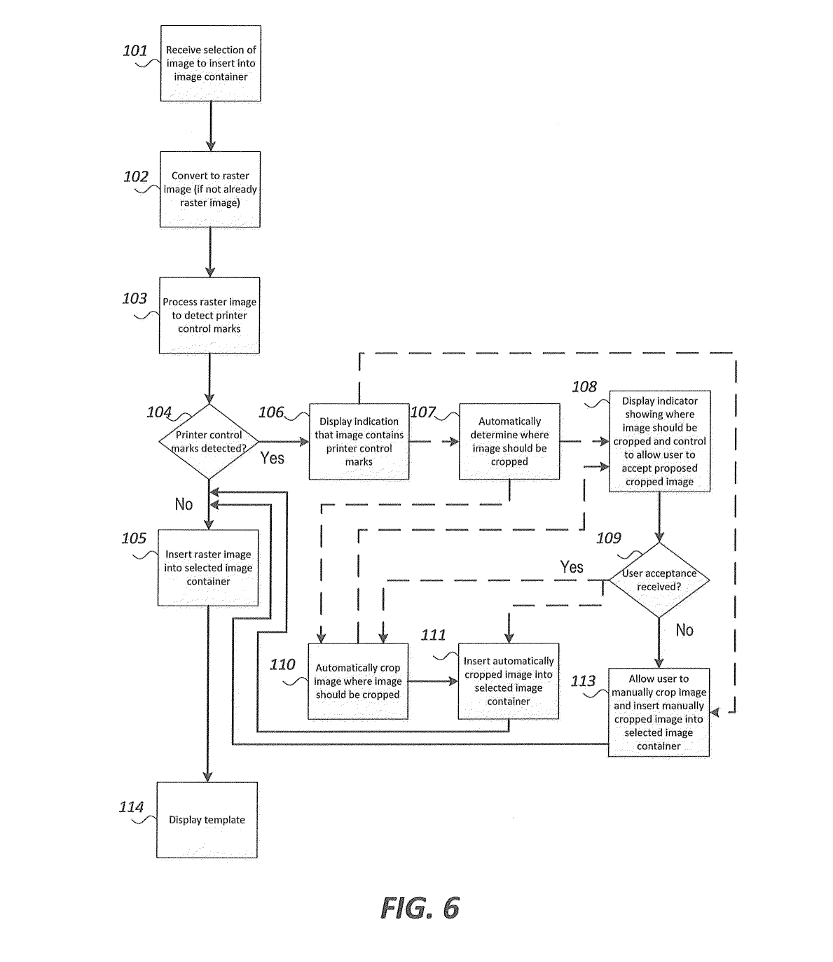

FIG. 6 is a flowchart of an exemplary method performed by the server computer 110, an particular the printer control mark detection function 115 of the computer system 110. As illustrated, the computer 110 receives a selection of an image to be inserted into a selected image container 24 (step 101). If the image is not already in a raster format (e.g., a .jpg, .giff, etc.) the image is converted to a raster format (step 102). The raster image is then processed to detect printer control marks in the image (step 103).

If printer control marks are not detected (determined in step 104), the raster image is inserted into the selected image container (step 105) and the updated template image (i.e., the product design image 20) with the image inserted in the image container 24 is displayed (step 114).

If printer control marks are detected (determined in step 104), however, an indication to the user that the image does contain printer control marks is displayed on the display screen (step 106). The indication may take various forms. In an embodiment, the system 110 automatically determines where the image should be cropped (step 107). In general, all images that contain any printer control marks, typically always contain crop marks. Thus, in an embodiment, the system 110 selects the pixels coinciding with the crop marks as the row and column pixels along which the image should be cropped. In an embodiment, the system then automatically crops the raster image along the determined crop lines (step 110). In an alternative embodiment, an image containing an indicator such as dashed or solid lines overlaying the raster image along the determined crop lines is displayed to the user (step 108) and the user is offered a choice whether to accept the proposed crop, or deny the proposed crop (step 109). Alternatively, the system 110 may automatically crop the image at the determined crop lines (step 110), present both the uncropped version and the cropped version and allow the user to select one of the cropped version, the uncropped version, or alternatively, allow the user to invoke a manual crop tool to allow the user to manually crop the image prior to insertion of the image into the image container 24.

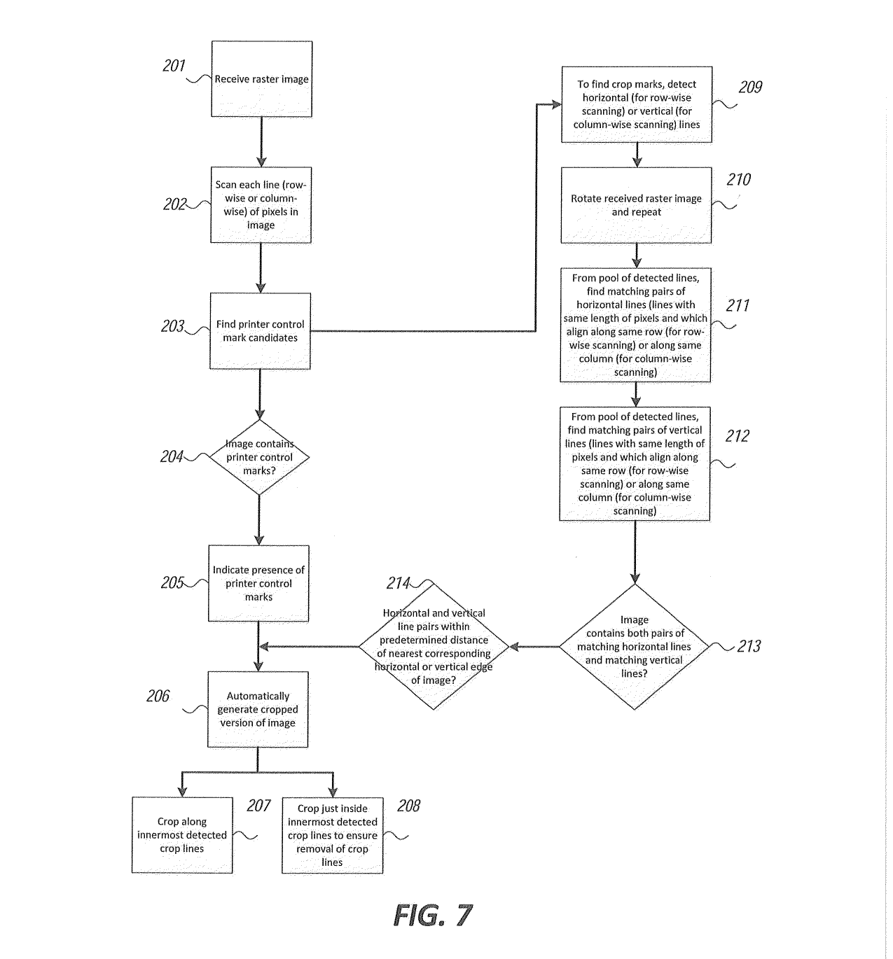

FIG. 7 is an exemplary method for determining whether a raster image contains printer control marks. As illustrated, the system receives the raster image (step 201). The system 110 then scans each line of pixels in the image (in either a row-wise or column-wise cadence) (step 202). The system 110 locates candidates for printer control marks (step 203) during and after the scan. If the system locates printer control marks (step 204), the system generates an indication that the image contains printer control marks (step 205). In an embodiment, the system 110 automatically generates a cropped version of the image (step 206). The cropped version of the image may be along the innermost detected crop mark candidates (i.e., on the crop line pixels themselves) (step 207) or may be just inside the inside the innermost detected crop lines (one or two pixels inside the detected crop line pixels) to ensure removal of the crop lines from the image (step 208)

To detect crop marks in the image, the system 110 locates lines of adjacent pixels of the same color located along horizontal lines (for row-wise scanning). (For column-wise scanning, the system looks for adjacent pixels of the same color located along vertical lines). The system then rotates the image by 90 or 270 degrees and repeats the search for horizontal (or vertical) lines (step 210). From the pool of detected lines, the system locates matching pairs of horizontal lines. Matching pairs of horizontal lines are lines with the same number (length) of pixels which align along the same row) (for row-wise scanning). Matching pairs of vertical lines are lines with the same number (length) of pixels which align along the same column) (for column-wise scanning) (step 211). From the pool of detected lines, the system locates matching pairs of vertical lines. Matching pairs of vertical lines are lines with the same number (length) of pixels which align along the same column) (for row-wise scanning). Matching pairs of vertical lines are lines with the same number (length) of pixels which align along the same row) (for column-wise scanning) (step 212).

If an image contains pairs of matching horizontal line candidates and pairs of matching vertical line candidates (determined in step 213), then the image likely contains crop marks. One common characteristic of such print control marks is that they typically lie in the margin of the printed product—that is, outside the target print area of content images to be, and/or that actually are, printed. Optionally, a check can be made (step 214) to determine that the detected crop mark candidates are within a predetermined distance (e.g., 0.5 inch or less) of the nearest respective edges of the image.

FIG. 8A shows an exemplary popup window 41 which is generated as an indicator that the selected image 5a contains printer control marks. In this embodiment, the user is shown the image with printer control marks, an automatically cropped and resized image with printer control marks removed, and an option to invoke a cropping tool to allow the user to manually crop the image. FIG. 8B shows the insertion of the automatically cropped image into the image container 24 after the user selects the system adjusted (automatically cropped) image from the options popup window 41. As will be appreciated, the system adjusted image 5c is most likely what the user intended when originally selecting the image (in FIG. 4C) for insertion into the image container 24.

While an illustrative embodiment has been discussed, alternate embodiments could also be employed. For example, while the invention has been described in a Web-based environment, it is not so limited. Therefore, the described embodiments are to be considered as illustrative rather than restrictive and the scope of the invention is as indicated in the following claims and all equivalent methods and systems.

What is claimed is:

1. A method for processing images for insertion into a selected image container of a document template, comprising:
receiving a rasterized image;
processing the received image to determine whether the received image contains any printer control marks;
providing an indication if the received image contains one or more printer control marks.

2. The method of claim 1, wherein the one or more printer control marks comprises one or more of a crop mark, a registration mark, a printer calibration mark.

3. The method of claim 1, wherein the indication provided is an alert to the user inserting the image into the selected image container of the document template that the image contains one or more printer control marks.

4. The method of claim 1, wherein the indication provided is a proposed cropped image comprising an automatically cropped version of the image which has been automatically cropped by the system to remove the detected one or more printer control marks from the image, the proposed cropped image being presented to the user to allow the user to accept the proposed cropped image for entry into the selected image container of the document template.

5. The method of claim 4, further comprising allowing the user to accept the proposed cropped image and in response to receiving user acceptance of the proposed cropped image, automatically resizing the proposed cropped image such that at least one dimension of the resized proposed cropped image matches a corresponding dimension of the image container.

6. The method of claim 6, wherein the automatically resizing includes maintaining an aspect ratio associated with the proposed cropped image.

7. The method of claim 1, wherein the indication provided is an automatically cropped version of the image which has been automatically cropped by the system to remove the detected one or more printer control marks from the image.

8. The method of claim 7, wherein the automatically cropped version of the image has further been automatically resized such that at least one dimension of automatically cropped version matches a corresponding dimension of the image container.

9. The method of claim 8, wherein the automatically cropped version of the image has an aspect ratio which matches the received image.

10. The method of claim 1, wherein the step for processing the received image to determine whether the received image contains any printer control marks comprises:
scanning the received image to locate horizontal and vertical line candidates;
finding pairs of horizontal lines which match in pixel length and are positioned along a same horizontal in the image;
finding pairs of vertical lines which match in pixel length and are positioned along a same vertical in the image;
if one or more matching horizontal line pairs and one or more matching vertical line pairs are found, determining that the image includes printer control marks.

11. The method of claim 10, further comprising determining that the image includes printer control marks only if at least one set of matching horizontal line pairs and one set of matching vertical line pairs is found within a predetermined pixel distance from the nearest corresponding horizontal or vertical edge of the received image.

12. A system for processing images for insertion into a selected image container of a document template, comprising:
one or more processors configured to receive an image;
one or more processors configured to process the received image to determine whether the received image contains any printer control marks;
one or more processors configured to provide an indication if the received image contains one or more printer control marks.

13. A method for detecting printer control marks in a rasterized image, comprising:
scanning the image line by line to find horizontal and vertical line candidates;
finding matching pairs of horizontal and vertical line candidates from the horizontal and vertical line candidates, matching pairs comprising candidates having a same length in terms of number of adjacent pixels and aligned along a same row or column;
indicating that the image contains printer control marks if matching pairs of both horizontal line candidates and vertical line candidates are found.

14. A system for detecting printer control marks in a rasterized image, comprising:
one or more processors configure to scan the image line by line to find horizontal and vertical line candidates;
one or more processors configure to find matching pairs of horizontal and vertical line candidates from the horizontal and vertical line candidates, matching pairs comprising candidates having a same length in terms of number of adjacent pixels and aligned along a same row or column;
one or more processors configure to indicate that the image contains printer control marks if matching pairs of both horizontal line candidates and vertical line candidates are found.
